(19) United States
(12) Patent Application Publication
(10) Pub. No.: US 2014/0305868 A1
(43) Pub. Date: Oct. 16, 2014

(54) PROCESS OF STABILIZING ACTIVATED SLUDGE IN WASTEWATER TREATMENT

(71) Applicant: YA-CHUNG WEI, TAOYUAN COUNTY (TW)

(72) Inventor: YA-CHUNG WEI, TAOYUAN COUNTY (TW)

(21) Appl. No.: 14/147,281

(22) Filed: Jan. 3, 2014

(30) Foreign Application Priority Data
Apr. 10, 2013 (TW) 102112702

(51) Int. Cl. C02F 3/12

(52) U.S. Cl. CPC C02F 3/1226
USPC 210/626

(57) ABSTRACT

A process of stabilizing activated sludge wastewater treatment using chitosan includes the following steps. Firstly, an activated sludge wastewater treatment system is provided. The activated sludge treatment system includes an aeration tank, a settlement tank, a sludge recycling device and a sludge exhausting device. The aeration tank receives mixed liquor and is connected to the settlement tank. The settlement tank outputs clean water. Secondly, chitosan is provided in the form of cationic polyelectrolyte. Finally, chitosan is added to the activated sludge treatment system by a dispenser.

### BACKGROUND OF THE INVENTION

1. Field of the Invention

The instant disclosure relates to activated sludge in wastewater treatment. In particular, it relates to a process of stabilizing activated sludge in wastewater treatment by chitosan.

2. Description of Related Art

The activated sludge in water treatment is composed of microbes, protozoa and metazoan in which the microbes emit polysaccharide colloid agglutinating organisms to form biological floc. Sludge bulking refers to the poor agglutination of sludge floc. Such sludge system is slow settling or even unsettling in a settlement tank. Under this situation, the activated sludge quickly piles up in the settlement tank and the effluent has a large amount of suspensions which results in failure to meet the regulatory standard of water quality. Sludge bulking can be categorized into two main phenomenon: diffuse sludge and over-growth of filamentous bacteria. Diffuse sludge is characterized by under-sized zooglea (flocs) and too few filamentous bacteria (i.e., FI=0-1, Filament Index, Eikelboom, 2000). Therefore, the sludge does not agglutinate as expected and loosely overflows from the settlement tank. This phenomena can be controlled by the addition of coagulant. However, in the case of over-growth of filamentous bacteria, the sludge floc is too loose to precipitate in the final clarifier where drifting biomass causes the mixed liquor to be unsettled. The filamentous bacteria are not dominant organisms in the sludge environment at normal conditions. Nevertheless, the filamentous bacteria can obtain more nutrients pro their large specific surface area when the growing conditions suddenly change, and therefore the filamentous bacteria become the dominant species. The amount of other microbes is relatively less and so scarce to form zooglea in the sludge system where the removal of organic sewage is reduced accordingly. The factors causing filaments overgrowth might be attributed to bacterial mutation, imbalanced food/microbe ratio, malnutrition, loading change, poor aeration and the like.

The addition of substances into sludge system is a fast and effective way to solve sludge bulking in the water-treatment plant. The applied additives should be able to inhibit the growth of filamentous bacteria or enhance the agglutination of the sludge. The conventional technique has implemented bactericide, coagulant or the combination of the two. The most effective and direct way is adding the bactericide to eliminate the filamentous bacteria. Currently, the most applied bactericide is oxidative such as chloride, hydrogen peroxide and etc. However, as the bactericide kills the filamentous bacteria, the other microbes and protozoa can be destroyed too. The water quality is significantly compromised at the initial stage of dosing additives. The activated sludge process cannot carry on until a new microorganism phase is established. It must take a long period of time for the microbes being cultured to recover the activated sludge to proper function.

The addition of coagulant in the aeration tank and the settlement tank can improve the flocculation of the sludge and immediately reduces sludge bulking. However, it cannot root out the factors that promote the growth of filamentous bacteria and therefore the bulking phenomenon will occur again for a relatively short duration. The coagulant usually interferes with the biological activity of the recycle sludge. Its dosage has to be under strict control so as to reduce the poisonous effect on the activated sludge. The conventional water-treatment chemicals including bactericide and flocculant have been applied for resolving the bulking problem, for example, hypochlorite, hydrogen peroxide, aluminum chloride, aluminum sulfate and the like. In addition, the art of dosing has advanced with the time to develop specific reagents for solving the issues arising from the filamentous bacteria and sludge bulking. The literature review in the relevant field has disclosed innovative agents including bactericides as shown in the U.S. Pat. Nos. 7,638,055, 6,165,364, 5,395,530, 5,324,432, 4,891,136 and 4,772,396, surfactants as shown in the U.S. Pat. No. 5,536,410 and publication No. 2003/0052059, polyelectrolyte as shown in the U.S. Pat. No. RE34,343, 4,729,831, RE34,127 and 4,732,684, multivalent metallic salt as shown in the U.S. patent publication No. 2011/0139714 or the like.

Chitosan is the second most abundant natural polymer on earth right after the cellulose. The raw material is derived from recycling the shells of crustaceans. The chemical composition of chitosan is polysaccharide which is safe, non-toxic and edible. Chitosan is a bio-degradable material having an outstanding ability in physical adoption and many biological activities. It is antibacterial, fungi-proof and anti-inflammation and helps in blood clotting as well as skin tissue repairing. Chitosan has been widely used in medicine, food, agriculture, industry and the others. It is made into different products like surgical threads, artificial skin, health food, cosmetics, biological pesticide and the others.

Chitosan polymer can adsorb the suspension, heavy metal, acidic anion, organic and inorganic chemicals in the water. It has been employed in the wastewater treatment as coagulant, adsorbent, separation film or the like. The application of chitosan in the wastewater treatment includes (1) chitosan flocculation as shown in the U.S. Pat. Nos. 8,168,767, 7,790,042, 7,749,391, 7,674,379, 7,384,573, 7,201,856, 7,157,009, 6,827,874, 6,821,427, 6,749,748, 5,543,056, 5,453,203, 5,433,865, 5,393,435, 5,336,415 and 3,533,940; (2) chitosan adsorption as shown in the U.S. Pat. Nos. 7,601,211, 7,326,344, 6,786,336 and 4,879,340; (3) chitosan antimicrobial as shown in the U.S. Pat. Nos. 6,093,422 and 6,217,780; (4) chitosan deodorization as shown in the U.S. Pat. No. 5,766,465, European patent No. 0,655,420, 0,819,099 and Japanese patent No. 05-038360, which were used to treat drinking water and wastewater. Regarding the activated sludge, chitosan has served as coagulant to replace synthetic polymer. Chitosan has been applied to treat the waste activated sludge that improves the dewatering operation of sludge, reduces the volume of sludge and avoids secondary pollution caused by chemical coagulants, as disclosed in the U.S. Pat. Nos. 4,710,298, 4,609,470 and 4,382,864. Only few articles discussed the application of chitosan in the principal part of activated sludge system. Straind et al (Water Research, 36, pp 4745-4752, 2002) used chitosan to cause microbe agglutination in the water. Bing Qin et al (Journal of Wuhan University of Technology, 31(6), pp 86-91, 2009) described that chitosan was not decomposed by organisms nor served as a source of nutrition to the microbes in the activated sludge system. According to the experimental results of the oxygen consumption by the activated sludge, the antimicrobial property of chitosan was mentioned in this study. However, it limited in the discussion of chitosan basic property but unconcerned on the application of antimicrobial in improving activated sludge and wastewater treatment. The U.S. patent publication No. 2010/020680 used chitosan to reduce the excess sludge in a biological reactor and save the operation cost for the sewage treatment plant, but did not mention the aspect of sludge bulking.

To address the above issues, the inventor strives via associated experience and research to present the instant disclosure, which can effectively improve the limitation described above.

### BRIEF SUMMARY OF THE INVENTION

The instant disclosure provides a process of stabilizing activated sludge in wastewater treatment by the use of chitosan.

According to one exemplary embodiment of the instant disclosure, the process includes the following steps. Firstly, an activated sludge wastewater treatment system is provided. The activated sludge treatment system includes an aeration tank, a settlement tank, a sludge recycling device and a sludge exhausting device. The aeration tank receives mixed liquor and is connected to the settlement tank. The settlement tank outputs clean water. Secondly, chitosan is provided in the form of cationic polyelectrolyte. Finally, chitosan is added to the activated sludge treatment system by a dispenser.

Chitosan inhibits the growth of filamentous bacteria, prevents sludge bulking and preserves normal microbiological environment. Additionally, the chitosan polyelectrolyte exhibits flocculation and adsorption and therefore is capable of replacing the conventional flocculatant and adsorbent in the wastewater treatment. That is to say, the presence of chitosan simplifies the wastewater treatment process.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 is a schematic diagram showing the wastewater treatment system of activated sludge of the instant disclosure.

FIG. 2 is a flow chart showing the process for stabilizing a wastewater treatment system of activated sludge of the instant disclosure.

FIG. 3 is a chart showing experimental results of SVI for comparing a test group with a control group in a wastewater treatment system of activated sludge of the instant disclosure.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

The instant disclosure applies chitosan in water treatment that provides multifunction including inhibiting the growth of filamentous bacteria, flocculating suspension, and adsorbing chemicals, and therefore an activated sludge system can be stabilized and improved. Chitosan is derived from the waste recycle of crustacean shell. The source is sustainable and its manufacture process is eco-friendly. The constitution of chitosan is a natural polysaccharide which is safe, non-toxic and edible. It is also well known to be bio-degradable, and therefore there is no ecological impact resulting from the application of chitosan. Chitosan shows great advantages in water treatment. Chitosan chemical structure is shown in Formula (I).

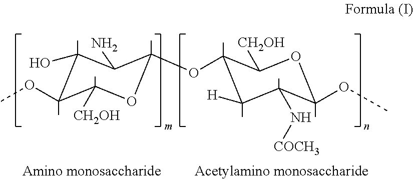

Chitosan consists of two moieties: amino monosaccharide and acetylamino monosaccharide. The physical, chemical and biological properties of chitosan are governed mainly by two factors: molecular weight (MW) and degree of deacetylation (DD=m/(m+n)). The amino-polysaccharide of chitosan has been proved to widely inhibit the growth of microbes. The relevant articles are published and indicate that it can broadly and effectively inhibit the growth of microbes including bacteria, fungi, yeast and algae. The inhibition rate of microbe growth by chitosan is relatively slow and is therefore categorized as an antimicrobial. Chitosan is unlike bactericide, for example, bleach or hydrogen peroxide which rapidly kills microbes by oxidation. In the instant disclosure, chitosan is used as antimicrobial to inhibit microbe growth in the activated sludge system. The mechanism of chitosan inhibition is mild and can be easily controlled and therefore maintains the biological balance and avoids large scale microbe death which leads to impotence of activated sludge.

Chitosan is insoluble in water yet soluble in diluted acidic solution (i.e. pH<6.3) wherein its amino groups receive protons and are converted from −NH₂ to −NH₃⁺. Chitosan dissolves in diluted acidic solution, and the polymer chain is in a cationic polyelectrolyte form. Chitosan can act as base and combine with organic or inorganic acid to form a salt. The solid of chitosan salt is soluble in water and can be dissociated to generate cationic polyelectrolyte and acidic anion. The polymer chain of chitosan is positively charged, which is extended and has high electrical density. Therefore, chitosan shows strong adsorption and flocculation in water by forming colloid precipitates to remove containments and clarify the water. The chitosan polyelectrolyte attracts suspension through its extended chain by Van der Waals force. In addition, the polymer chain has high electrical density such that it attracts negatively charged particles and anionic solutes by electrostatics. Furthermore, the amino group of chitosan polymer exhibits chelation to heavy metals and transition metal. In this regard, the polymer chain of chitosan is capable of both flocculation and adsorption. Chitosan can simplify the waste treatment process if the only polymer is employed in replacing two chemicals applied conventionally, coagulant and adsorbent.

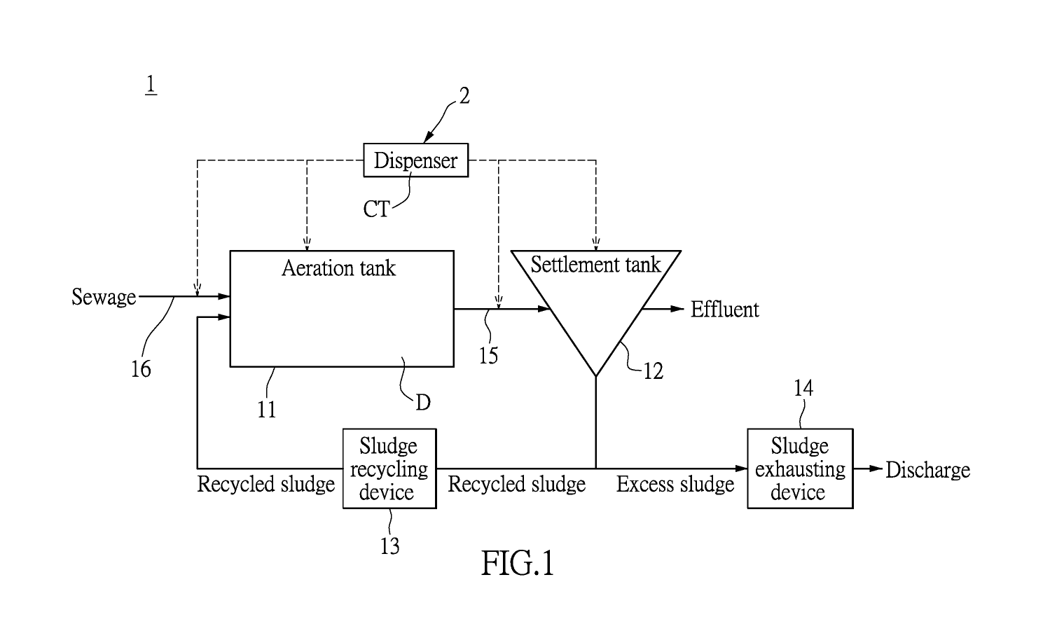

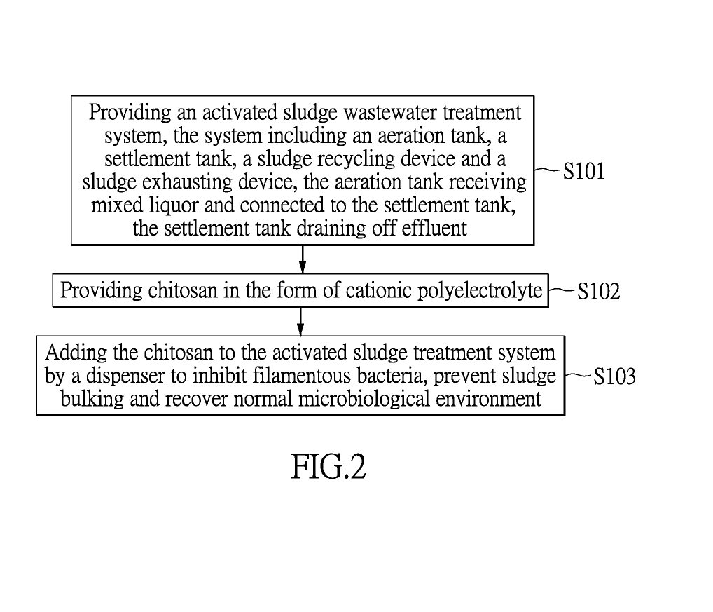

The following embodiments further elaborate the instant disclosure, yet the instant disclosure is not limited thereto. Please refer to FIG. 1 in conjunction with FIG. 2. FIG. 1 is a schematic diagram showing a system of an activated sludge wastewater treatment of the instant disclosure. FIG. 2 is a flow chart showing a process of stabilizing the activated sludge wastewater treatment system of the instant disclosure. As shown in FIGS. 1 and 2, to avoid filamentous bacteria from overgrowth, which leads to sludge bulking, the instant disclosure adds chitosan in an activated sludge wastewater treatment system 1 to inhibit bacterial growth, increase adsorption, flocculation and settling and maintain a stable activated sludge state. The desirable biological activity of activated sludge D can be prolonged and continue to purify the water in sewage processing. The chitosan CT can be in the form of liquid, solid or colloid and the instant disclosure is not limited thereto. As long as the chitosan CT is in the form of cationic polyelectrolyte, it corresponds to the instant disclosure. The chitosan CT is in cationic polyelectrolyte form in the wastewater.

Please refer to FIGS. 1 and 2. The process of stabilizing the activated sludge wastewater treatment system includes: providing the activated sludge wastewater treatment system 1 and a dispenser 2. The activated sludge wastewater treatment system 1 includes an aeration tank 11, a settlement tank 12, a sludge recycling device 13 and a sludge exhausting device 14. The front end of the aeration tank 11 receives wastewater, and the rear end of the aeration tank 11 connects to the settlement tank 12. The rear end of the settlement tank 12 outputs clear supernatant. The chitosan CT in the form of cationic polyelectrolyte in the wastewater is also provided. The chitosan CT is added to the activated sludge wastewater treatment system 1 by the dispenser 2. The chitosan CT effectively inhibits the growth of filamentous bacteria, prevents sludge bulking and recovers normal microbiological environment in the activated sludge D.

Please refer to FIG. 2. In the step of providing the activated sludge wastewater treatment system 1 and the dispenser 2, the wastewater and return sludge D enter the aeration tank 11 together to form the mixed liquor. An air compressor (not shown) delivers compressed air and an air diffusion device (not shown), which is disposed on the bottom of the aeration tank 11, pumps tiny air bobbles to the mixed liquor. The dissolved oxygen concentration in the mixed liquor is then increased, and the mixed liquor is under constant vigorous stirring. The dissolved oxygen, return sludge D and wastewater are fully mixed in suspension, and the activated sludge reaction is carried out. The activated sludge reaction includes a first stage and a second stage. During the first stage, the activated sludge D has large amount of polysaccharide adsorbed on its surface. The organic sewage in the wastewater is attached to the zooglea of the activated sludge. In the presence of exoenzyme, large organic molecules are digested to small organic molecules. During the second stage, if the microbes have sufficient oxygen, organic materials are absorbed as nutrition and digested by oxidation to form carbon dioxide and water. The organic sewage in the wastewater is decomposed and removed, and the activated sludge D can reproduce and grow. The mixed liquor, which goes through the purification provided by the activated sludge D, enters the settlement tank 12. Because the filamentous bacteria (less dominant species) in the activated sludge D can agglutinate and precipitate with other solid materials, the precipitated sewage can be segregated from the mixed liquor, and clearer supernatant is then obtained. The precipitated activated sludge D is exhausted from the bottom of the settlement tank 12. A portion of the activated sludge D is recycled to the aeration tank 11 as seeding sludge and carries out the purification. The remainder of over reproductive microbes and sewage are called “excess sludge”. The excess sludge goes through condensation, dehydration and the like and is discharged from the sludge exhausting device 14.

In the step of providing chitosan CT in the form of cationic polyelectrolyte in the wastewater, chitosan CT is ensured to be present in the form of cationic polyelectrolyte by pre-processing, for example, acidification or salinization, molecular weight modification or deacetylation, dosing or pH regulation. If sludge bulking occurs, the non-filamentous bacteria become the less dominant species in the activated sludge D. Zooglea are not sufficiently formed, and therefore the adsorption is compromised. Meanwhile, the chitosan is in cationic polyelectrolyte form, which shows strong tendency of adsorbing sewage in the wastewater and agglutinating as flocs. Chitosan rapidly makes up the lack of zooglea, which is formed by the non-filamentous microbes, adsorbs the sewage and purifies the mixed liquor. In addition, chitosan CT inhibits filamentous bacteria growth. Chitosan CT polyelectrolyte gradually degrades to chitosan oligosaccharide and continues the inhibition of the growth of filamentous bacteria. Its effectiveness may last for a few weeks to allow filamentous bacteria and the other microbes to recover to normal biological state and relieve sludge bulking.

In the step where chitosan CT is added to the activated sludge wastewater treatment system 1 by the dispenser 2, the aeration tank 11 is also the main place where the sewage is decomposed. In other words, the aeration tank 11 has the most vibrant biological activity. Chitosan CT can be dosed at the front end of the aeration tank, the aeration tank, the rear end of the aeration tank or the settlement tank 12. For example, when sludge bulking occurs, the activated sludge D accumulates fast in the settlement tank 12. The accumulation leads to large amount of suspension in the supernatant and a failure in supernatant quality. In this scenario, preferably, the dosing site of chitosan CT is assigned at the rear end of the aeration tank 11. More specifically, as shown in FIG. 1, because at least one conduit 15 is arranged between the aeration tank 11 and the settlement tank 12, chitosan CT can be dosed or mixed into the at least one conduit 15 and feed the settlement tank 12. When the chitosan CT is added to the rear end of the aeration tank 11 that connects to the conduit 15, chitosan CT can be sufficiently mixed with the activated sludge treated water (i.e., water from the aeration tank 11) and then both enter the settlement tank 12 together. Because the water body is in a slow mixing state in the settlement tank 12, chitosan CT adsorbs and agglutinates with the sewage of the activated sludge. In this regard, activated sludge bulking is effectively reduced, and the supernatant in the settlement tank 12 achieves discharging standard more quickly. Additionally, well-mixed chitosan CT returns to the aeration tank 11 via the sludge recycling device 13. In other words, chitosan CT can directly react with the sewage and activated sludge D in the aeration tank 11 to save the treatment time in the aeration tank 11. In short, dosing chitosan CT to the rear end of the aeration tank 11 is an immediate means to reduce sludge bulking and accelerates supernatant purification to the discharging standard.

It is worth noting that chitosan is applied to water containing activated sludge D where the strength of activated sludge is variable. There are two measurement criteria for chitosan dosing: based on the mass of water (dosage/water mass) and based on the mass of activated sludge (dosage/sludge mass). In practice, these two measurement criteria are available for using to control the chitosan dosage precisely according to circumstances. When the concentration of activated sludge D is low, the chitosan CT is applied by following the dosage guide based on the mass of water to ensure its effectiveness. When the concentration of the activated sludge D is high, the dosing guide of chitosan CT is applied based on the mass of the activated sludge D to ensure its effectiveness. The actual figures are shown for chitosan CT dosed in the water containing activated sludge D. Preferably, the effective dosage of chitosan CT falls between 1-5000 ppm based on the mass of water of water for the low strength of active sludge D and between 10-1000 ppm based on the mass of water for the high strength of active sludge D.

Moreover, as shown in FIG. 1, chitosan CT can be dosed at the front end of the aeration tank 11. More specifically, the front end of the aeration tank 11 has at least one pipe 16 for sewage feeding where chitosan CT can be dosed in the pipe 16. Chitosan CT must be fully mixed with the sewage, then enters the aeration tank 11 and interacts with the microbes for a longer period. In this way of prolonging interaction, chitosan CT inhibits filamentous bacteria growth more effectively and stabilizes the biological environment. That is to say, the sludge bulking in the aeration tank 11 can be prevented or improved by dosing chitosan CT at the front end of the aeration tank 11. Subsequently, the bulking sludge is also reduced in the settlement tank 12, and the clear supernatant can then run off. Further still, chitosan CT can be applied at both ends, the front and the rear of the aeration tank 11 such that chitosan CT works in the aeration tank 11 and the settlement tank 12 at the same time. It specifically accelerates the inhibition of abnormal growth of filamentous bacteria and reduces bulking sludge in the aeration tank 11 and settlement tank 12 simultaneously and speedily, stabilizes the activated sludge and therefore enhances the water quality of effluent greatly.

It is worth noting that when the activated sludge wastewater treatment system 1 shows serious abnormality (e.g., activated sludge bulking), chitosan cationic polyelectrolyte solution can be directly spread to the aeration tank 11 or the settlement tank 12 to fast inhibit bacterial growth, adsorption, agglutination and settling. The activated sludge bulking can be immediately controlled thereby. In this case, the strength of sludge D in water is high so that it is to say the dosage guide of chitosan CT falls between 0.01%-10% based on the active sludge. The cationic polyelectrolyte solution of chitosan can be simultaneously spread on the water surfaces of the aeration tank 11 and the settlement tank 12.

It is worth mentioning that according to experimental results, the process of stabilizing the activated sludge of the instant disclosure effectively controls the abnormal activated sludge bulking by 2-4 hours after dosing chitosan CT directly to the aeration tank 11 or the settlement tank 12.

In short, the instant disclosure is a method for stabilizing biological system in water treatment, which utilizes chitosan CT to improve the performance of activated sludge D for wastewater treatment. Chitosan inhibits microbe growth in a mild manner such that the microbes are not killed in a large scale. The biomass is therefore maintained in a steady state. The activated sludge D does not lose its effectiveness in the presence of chitosan CT. As a result, the activated sludge D can be sustained to clean waste water without undesirable changing. The cost and time are both saved in the instant disclosure. Furthermore, because microbes are not acutely killed by chitosan CT in the instant disclosure, the biological system is stable and effective for water treatment during the recovery from bulking and it is not necessary to cease the operation until the sludge is activated to a proper level. That is to say, the instant disclosure is eco-friendly, energy efficient, sustainable, unaffected by weather and cost efficient.

Examples are provided herein to further support the advantages of the instant disclosure. SV30, MLSS, SVI are used to quantify the process of stabilizing activated sludge wastewater treatment system of the instant disclosure to ensure chitosan effectiveness in the activated sludge system 1. SV30, MLSS and SVI are further elaborated herein. Sludge volume index (SVI) is used as an indicator for monitoring activated sludge wastewater treatment system. SVI is measured by taking mixed liquor sample from the aeration tank 11, resting for 30 minutes and calculating the volume occupied by 1 g of settled activated sludge D. Standard SVI of activated sludge D usually falls between 50-150. If SVI is lower than the abovementioned value, it indicates that the activity of the sludge is worse. If SVI is too high, it indicates the occurrence of sludge bulking. SVI can climb up to 300-400 in abnormal state. Typically, activated sludge D of the mixed liquor achieves a steady state after a 30-minute resting. That is the reason a time window of 30 minutes is used to measure the settling ratio of activated sludge D (SV30 is the ratio of the volume of settled sludge to the total volume of the mixed liquor). It is a fast indicator for monitoring activated sludge D. The mixed liquid suspended solid (MLSS) is used to measure concentration of mixed liquor suspended solids (mg/L) in the activated sludge D sample obtained from the mixed liquor. SV30 and MLSS are obtained from the activated sludge D sample, and SVI is derived from Equation I.

SVI=SV₃₀ (%)×10⁴/MLSS (mg/L) Equation (I)

### Example 1

Activated sludge D sample taken from a wastewater treatment plant was examined in a lab-scale activated sludge system. The effectiveness of chitosan CT inhibiting filamentous bacteria in the activated sludge D was observed. The activated sludge D was obtained from an industrial sewage treatment plant where sludge bulking occurred as the seasons change. The mixed liquor was collected from the rear end of the aeration tank 11. After sampling, the tests were conducted immediately. The activated sludge D read MLSS=2250 mg/L, SV30=0.79 and SVI=360. The biological activity was observed under microscope, and filamentous bacteria were identified as dominant organism, and flocs were in irregularly loose shape.

Chitosan CT was mixed with acetic acid into a liquid and rested for 5 days to achieve a homogeneous state. Then, water was added to form a 0.1% (w/w) chitosan CT clear liquid for testing. In addition, skimmed milk was dissolved in water to prepare sewage sample. Five-liter batch reaction tank was used. The reaction tank was filled with 2 L activated sludge liquid and installed with aeration and stirring equipment. The dissolved oxygen concentration was maintained at 2-3 mg/L. The activated sludge sample obtained from the rear end of the aeration tank 11 was allowed to precipitate in the Imhoff cone for 60 minutes. The supernatant (200 mL/L) was removed and the activated sludge D was kept at the bottom. The sewage sample and then the chitosan CT solution were added into the Imhoff cone. The volume is equivalent to the removed supernatant. The activated sludge mixed liquor as called chitosan experimental sludge was placed in the reactor. Blank control sludge did not have chitosan CT solution while the rest conditions were exactly the same. The characteristics of the blank control sludge and the chitosan experimental sludge are shown in Table I.

TABLE I
Characteristics of activated-sludge mixed liquids before batch operations

| | MLSS | Chitosan | |
|---|---|---|---|
| Mixed liquor sample | (mg/L) | (% MLSS) | SVI |
| Chitosan experiment | 2190*¹ | 9.1 | 350*¹ |
| Blank control | 2250 | 0 | 360 |

(*¹indicates the values obtained before chitosan addition.)

The sludge systems were performed in the reactor for 5 days. Sludge sampling was taken everyday. Periodic samples were assessed biological activity by microscope and measured SVI. The biological activity was shown in Table II where the observed results were evaluated according to Eikelboom Filament Index (FI) (D. H. Eikelboom, Process control of activated sludge plants by microscopic investigation, 2000). In chitosan experimental sludge, the 9.1% MLSS of chitosan CT was added. After one day, the number of filamentous bacteria significantly reduced. Initially they occupied most of the space, and then they scattered around the flocs. After two days, filamentous bacteria continued to reduce, and the flocs increased. After three days, there was no filamentous organism outside the flocs, and the biological activity achieved a stable state.

TABLE II
Investigation and evaluation of filamentous organisms in the activated
sludge

| | |
|---|---|
| Microscopic observation | FI*¹ |

Chitosan experiment

| | | |
|---|---|---|
| Day 1 | Filamentous bacteria emerging from flocs and | 3 |
| | detached the flocs | |
| Day 2 | Filamentous bacteria emerging from flocs and | 1 |
| | aggregated flocs | |
| Day 3 | Filamentous bacteria embedded within the flocs | 0 |
| Day 4 | Filamentous bacteria embedded within the flocs | 0 |
| Day 5 | Filamentous bacteria embedded within the flocs | 0 |

Blank control

| | | |
|---|---|---|
| Day 1 | Filamentous bacteria occupied most space, | 5 |
| | small flocs linked by abundant filament | |
| Day 2 | Filamentous bacteria occupied most space, | 5 |
| | small flocs linked by abundant filament | |
| Day 3 | Filamentous bacteria occupied most space, | 5 |
| | small flocs linked by abundant filament | |
| Day 4 | Filamentous bacteria occupied most space, | 5 |
| | small flocs linked by abundant filament | |
| Day 5 | Filamentous bacteria occupied most space, | 5 |
| | small flocs linked by abundant filament | |

(*¹indicates that FI was ranged according to Eikelboom standard chart for filamentous organisms evaluation, scale 0-5, 0 = none, 5 = overabundance.)

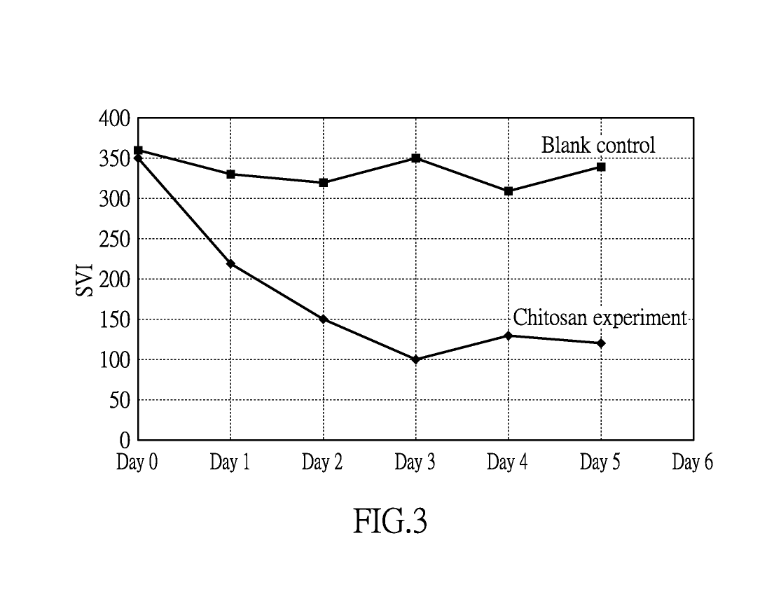

Please refer to FIG. 3. FIG. 3 is a chart showing SVI experimental results of a test group and a control group. As shown in FIG. 3, it revealed that the addition of chitosan CT can improve the settling of activated sludge. After two days of dosing, activated sludge bulking was resolved and the system returned to normal condition.

### Example II

The experiment was conducted in a sewage treatment plant having sludge bulking. The plant uses activated sludge system to process industrial wastewater. The wastewater flow was about 100 M³/hour. The aeration volume was 80,000 M³. The settlement tank volume was 1,000 M³. Before dosing chitosan, the SVI was 380 in the aeration tank 11. Activated sludge overflowed the settlement tank, and SV30 was 99% in the settlement tank 12.

Chitosan chloride salt was made by using hydrochloric acid. The chitosan polyelectrolyte concentration was 10 g/L in water, prepared as the working solution of polyelectrolyte. The dosing point of chitosan was at the rear-end outlet of the aeration tank 11. A pump fed chitosan polyelectrolyte solution into the water at a speed of 200 L/hour, and then going through the conduit. The solution immediately mixed with the water in the conduit and entered the settlement tank. The flow became slower and mixed gradually in the settlement tank. The activated sludge agglutinated and settled. The pump operated for 10 hours, and the sludge was not discharged but recycled entirely during the testing period. When the dosage was finished, excess sludge was discharged.

Water samples were collected from the central region of the settlement tank 12 and measured the SV30 at the 5^{th}, 10^{th}, 15^{th}, and 20^{th} hours after the first dosage. Samples were also collected from the rear end of the aeration tank 11 at an assigned time everyday, and the SVI values were obtained therefrom. Results were shown in Table III.

TABLE III

| Running Time | Sampling Site | SV₃₀ (%) | SVI (ml/g) |
|---|---|---|---|
| Day 0 before dosage | Aeration tank | | 380 |
| Day 0 before dosage | Settlement tank | 97 | |
| Day 0 5^{th} hour | Settlement tank | 50 | |
| Day 0 10^{th} hour | Settlement tank | 24 | |
| Day 0 15^{th} hour | Settlement tank | 42 | |
| Day 0 20^{th} hour | Settlement tank | 40 | |
| Day 1 | Aeration tank | | 420 |
| Day 2 | Aeration tank | | 360 |
| Day 3 | Aeration tank | | 410 |
| Day 4 | Aeration tank | | 280 |
| Day 5 | Aeration tank | | 180 |
| Day 6 | Aeration tank | | 140 |
| Day 7 | Aeration tank | | 130 |

According to the SVI of the aeration tank 11 and the SV30 of the settlement tank from the abovementioned experiment, it is clear that after 5 hours of dosage, the SV30 of the settlement tank 12 dropped from 97% to 50%. The activated sludge did not overflow and the supernatant became clearer. After 4 days of dosage, the aeration tank 11 also showed improvement, and on the fifth day a stable state was reached.

In summary, the process of stabilizing activated sludge wastewater treatment system provides advantages described below.

The process utilizes chitosan to flocculate and adsorb sewage in the activated sludge and therefore effectively reduces the occurrence of sludge bulking. Chitosan also inhibits abnormal growth of filamentous bacteria to maintain a steady biological environment and stabilizing the performance of the activated sludge for water treatment. The supernatant can achieve the required quality sooner as well. In the presence of chitosan, the activated sludge is less likely to malfunction or become impotent, and therefore the efficiency of wastewater treatment can be maintained at the desirable state. The activated sludge does not need to be replaced that often compared to the conventional wastewater treatment process such that time and cost are saved. The microbes in the activated sludge are not harmed and do not need to be recovered after the addition of chitosan. In other words, the process of the instant disclosure is eco-friendly, energy efficient, sustainable and unaffected by weather.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A process of stabilizing activated sludge in wastewater treatment, using chitosan, comprising:
providing an activated sludge wastewater treatment system, the activated sludge wastewater treatment system including:
an aeration tank, a settlement tank, a sludge recycling device and a sludge exhausting device, the aeration tank receiving mixed liquor and connected to the settlement tank, the settlement tank outputting supernatant;
providing chitosan in the form of cationic polyelectrolyte; and
adding the chitosan to the activated sludge treatment system by a dispenser to inhibit filamentous bacteria, prevent sludge bulking and recover normal microbiological environment.

2. The process of stabilizing activated sludge in wastewater treatment according to claim 1, wherein the chitosan is in solution, solid or dispersion state.

3. The process of stabilizing activated sludge in wastewater treatment according to claim 2, wherein the cationic polyelectrolyte is chitosan inorganic salt, chitosan organic salt or the combination of chitosan inorganic salt and chitosan organic salt.

4. The process of stabilizing activated sludge in wastewater treatment according to claim 1, wherein the chitosan concentration in the activated sludge mixed liquor ranges between 1 to 5000 ppm by weight of water.

5. The process of stabilizing activated sludge in wastewater treatment according to claim 1, wherein the chitosan concentration in the activated sludge mixed liquor ranges between 10 to 1000 ppm by weight of activated sludge.

6. The process of stabilizing activated sludge in wastewater treatment according to claim 1, wherein the chitosan concentration in the activated sludge mixed liquor ranges between 0.01 to 10% by weight of activated sludge.

7. The process of stabilizing activated sludge in wastewater treatment according to claim 1, wherein the chitosan is selectively dosed in the aeration tank, a front end of the aeration tank or a rear end of the aeration tank by the dispenser.

8. The process of stabilizing activated sludge in wastewater treatment according to claim 7 further comprising at least one conduit connecting the aeration tank and the settlement tank, wherein the chitosan is dosed in the at least one conduit.

9. The process of stabilizing activated sludge in wastewater treatment according to claim 7, wherein the aeration tank includes at least one pipe connected to the front end thereof to receive mixed liquor, and the chitosan is dosed in the at least one pipe.

10. The process of stabilizing activated sludge in wastewater treatment according to claim 1, wherein the chitosan is sprayed to the aeration tank or the settlement tank.

11. The process of stabilizing activated sludge in wastewater treatment according to claim 1, wherein the chitosan is simultaneously sprayed to the aeration tank and the settlement tank.
